(19) United States
(12) Patent Application Publication
(10) Pub. No.: US 2015/0378314 A1
(43) Pub. Date: Dec. 31, 2015

(54) Timer Device and Time Measurement System

(71) Applicant: SAKAI DISPLAY PRODUCTS CORPORATION, Sakai-shi, Osaka (JP)

(72) Inventor: Tetsuya Nakabayashi, Sakai-shi, Osaka (JP)

(21) Appl. No.: 14/765,970

(22) PCT Filed: May 29, 2014
(86) PCT No.: PCT/JP2014/064324

§ 371 Date: Aug. 5, 2015

(30) Foreign Application Priority Data
May 29, 2013 (JP) 2013-113370

(51) Int. Cl. G04F 1/00

(52) U.S. Cl. CPC G04F 1/005

(57) ABSTRACT

Provided are: a timer device allowing a user to visually and aurally recognize time related to an object and reducing a problem of passing a time limit related to the object, and a time measurement system including the timer device.

A timer device measuring time related to an object comprises at least one of: a light emission part changing a light emission property in accordance with measured time; a sound output part changing sound output property in accordance with measured time; and a display part changing a displayed content in accordance with measured time.

This application is the national phase under 35 U.S.C. §371 of PCT International Application No. PCT/JP2014/064324 which has an International filing date of May 29, 2014 and designated the United States of America.

### TECHNICAL FIELD

The present invention relates to a timer device measuring time and to a time measurement system including the timer device.

### DESCRIPTION OF RELATED ART

Conventionally, food items stored in a refrigerator may sometimes be expired because the user of the refrigerator cannot grasp the expiration time limits, i.e. use-before dates, for all food items that have different expiration time limits. Furthermore, as a refrigerator is restocked with food items purchased by the user one after another, a food item stored at the back of the refrigerator is hidden by another food item when the user overly puts food items into the refrigerator to exceed the capacity thereof, which causes the user to forget the existence and expiration time limit of a hidden food item. A food item past its expiration time limit may be discarded, resulting in waste of food as the food item cannot be consumed within the expiration time limit.

A refrigerator described in Japanese Patent Application

Laid-Open Publication Number 2001-201243 is able to register food items or the like in the refrigerator in advance based on data related to names of food items or the like, to allow the user to grasp an expiration time limit by setting the expiration time limit for a food item or the like with an operation unit located at a door of the refrigerator, and to manage a food item or the like in an integrated manner by displaying data including its expiration time limit on a display part located at the door of the refrigerator.

### SUMMARY

In order to use an almost expired food item without wasting it, it is important for the user to grasp the expiration time limit of the food item while looking at the food item in a refrigerator at the time point when the user opens a door of the refrigerator to use it.

The refrigerator described in Japanese Patent Application Laid-Open Publication Number 2001-201243 requires operation with an operation unit or confirmation on a display part in front of the door of the refrigerator, which prevents the user from grasping the expiration time limit of a food item in the refrigerator while looking at the food item.

Furthermore, in the refrigerator described in Japanese

Patent Application Laid-Open Publication Number 2001-201243, in order for the user to grasp the expiration time limit for a food item, it is necessary to look at the display part located on a door of the refrigerator after an operation is executed through an operation unit. Though food items may be displayed in such an order that a food item with the earliest expiration time limit is shown first, it is circuitous to look at the display part in front of the refrigerator door to check the expiration time limit of a food item. Furthermore, if the user opens the refrigerator door to directly hold the food item after looking at the display part, the action itself of looking at the display part may be inefficient.

Moreover, in the case of a device which uses a single operation unit to integrally manage the data of food items or the like, it is necessary to register, delete and set the data of food items that are constantly replaced in front of the device. Hence, if a failure occurs in the device for some reason, the user may not be able to grasp all the data of food items or the like stored in the device.

The present invention has been made in view of the circumstances described above, and aims to provide a timer device, which allows a user to visually and aurally recognize time related to an object and thereby alleviating the problem of passing an expiration time limit related to the object, and a time measurement system including the timer device.

A timer device according to the present invention measuring time related to an object comprises at least one of a light emission part changing a light emission property in accordance with measured time, a sound output part changing sound output property in accordance with measured time, and a display part changing a displayed content in accordance with measured time.

In the timer device according to the present invention, at least one of the light emission property of the light emission part, the sound output property of the sound output part and the display content of the display part varies in accordance with the measured time.

The timer device according to the present invention includes the light emission part, the sound output part and a light detection part, and is configured to stop operation of the light emission part and sound output part in the case where the light detection part detects light for a predetermined period.

In the timer device according to the present invention, electric power consumption is reduced by stopping the operation of the light emission part and sound output part automatically according to the above aunction.

The timer device according to the present invention further comprises a member for nipping the object.

In the timer device according to the present invention, an object can reliably be fixed and the association between the timer device and the object is clarified.

A time measurement system according to the present invention comprises: a plurality of timer devices according to any one of the timer devices described above; and a power supply device simultaneously supplying electric power to the plurality of timer devices.

In the time measurement system according to the present invention, in order to use the timer device, the timer device is supplied with electric power.

A time measurement system according to the present invention comprises: a plurality of timer devices according to the timer devices as described above; and a power supply device simultaneously supplying electric power to the plurality of timer devices. The aforementioned member is formed at an end of the timer device, and the member is attached to the power supply device to supply electric power to the timer device.

In the time measurement system according to the present invention, in order to use the timer device, the member is attached to the power supply device so as to supply electric power to the timer device.

In the time measurement system according to the present invention, each of the plurality of timer devices measures time related to each of a plurality of objects, and the time measurement system further comprises a display device displaying time obtained by subtracting the time measured for each of the plurality of objects from the time specified by each of the plurality of objects.

In the time measurement system according to the present invention, the timer device measures time related to each object, and the display device displays the time obtained by subtracting the measured time from the time specified by each object.

In the time measurement system according to the present invention, the plurality of timer devices constitute a pair of timer devices, and the pair of timer devices measure time related to the same object.

In the time measurement system according to the present invention, one pair of timer devices measure time related to the same object.

In the time measurement system according to the present invention, while one of the pair of timer devices measures time related to the object, the other of the pair of timer devices is supplied with electric power by the power supply device.

In the time measurement system according to the present invention, while one of the pair of timer devices measures time related to an object, the other of the pair is supplied with electric power by the power supply device.

With the timer device according to the present invention, the user is able to visually and aurally recognize time.

Furthermore, with the timer device according to the present invention, the user is able to visually and aurally recognize time related to an object, and therefore the problem of passing a time limit related to the object may be alleviated.

The above and further objects and features will move fully be apparent from the following detailed description with accompanying drawings.

### BRIEF DESCRIPTION OF THE SEVERAL VIEWS OF THE DRAWINGS

FIG. 1 is a perspective view illustrating an outer appearance of a timer device according to an embodiment of the present invention;

FIG. 2 illustrates an internal configuration of a timer device according to an embodiment of the present invention;

FIG. 3 is a flowchart illustrating a procedure of measuring time related to an object using a timer device according to an embodiment of the present invention;

FIG. 4 illustrates a charging unit to/from which a plurality of timer devices according to an embodiment of the present invention are detachable;

FIG. 5 illustrates a charging unit attached to a door of a refrigerator according to an embodiment of the present invention;

FIG. 6 illustrates an internal configuration of a timer device according to an embodiment of the present invention; and

FIG. 7 illustrates a time measurement system including a plurality of timer devices according to one embodiment of the present invention.

### DETAILED DESCRIPTION

While embodiments of the present invention will be described below with reference to the drawings, the present invention is not limited to the present embodiments. It is to be noted that, in the drawings referred to in the following description, components with the same function may be denoted by the same reference code and the description thereof may not be repeated.

In the present invention, a timer device measures time related to an object. The time related to an object may be, in the case where the object is a food item, time corresponding to an expiration time limit or a use-before date of a food item. Moreover, in the case where the object is a user provided with the timer device, the time related to an object may be, for example, time left before an event for the user.

### Embodiment 1

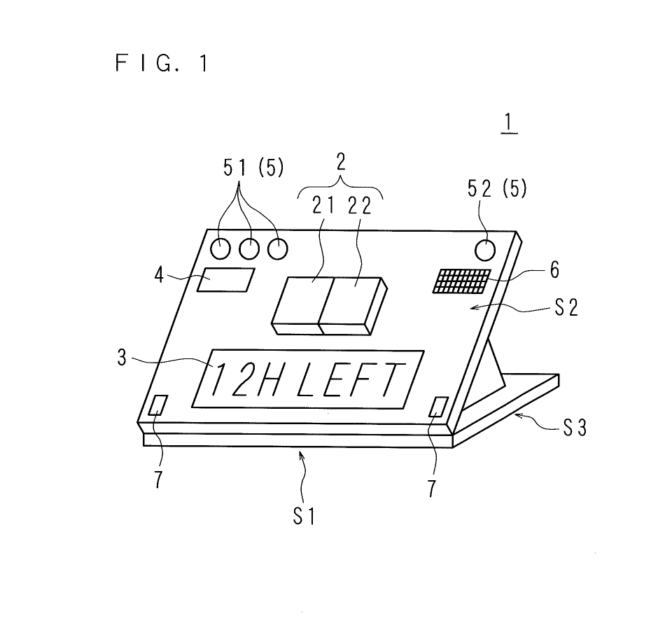

FIG. 1 is a perspective view illustrating an outer appearance of a timer device according to an embodiment of the present invention. In the present embodiment, the timer device 1 includes a time setting part 2, a display part 3, a light detection part 4, a light emission part 5, a sound output part 6 and a charging electrode 7. The timer device 1 has the shape of a clip which can nip an object, e.g., a food item, with an end of the timer device 1 as indicated by a reference code S1 in FIG. 1. Furthermore, though the appearance of the timer device 1 is formed by combining rectangular planes as indicated by reference codes S2 and S3 in the present embodiment, the appearance of the timer device 1 may also be formed by combining arbitrary planes having, for example, a circular or trianglar shape.

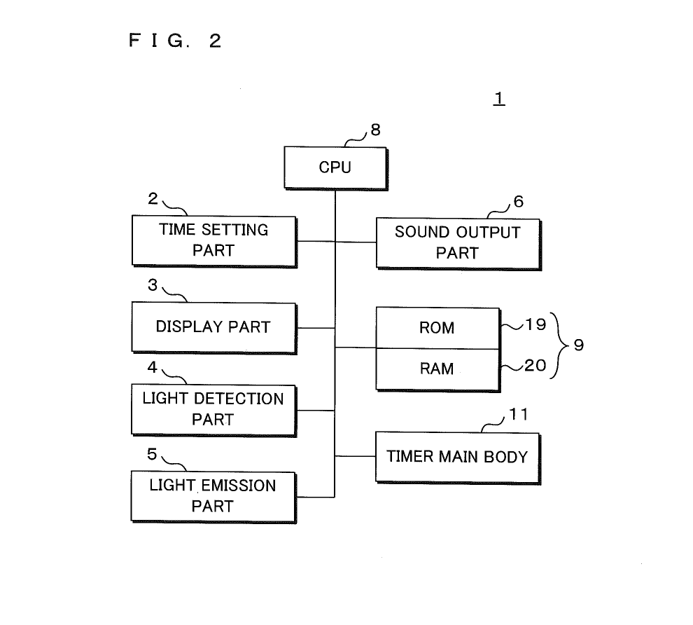

FIG. 2 illustrates an internal configuration of a timer device according to an embodiment of the present invention. In the present embodiment, the timer device 1 includes a time setting part 2, a display part 3, a light detection part 4, a light emission part 5, a sound output part 6, a CPU (Central Processing Unit) 8, a storage part 9 and a timer main body 11. The CPU 8 is connected to the time setting part 2, display part 3, light detection part 4, light emission part 5, sound output part 6, storage part 9 and timer main body 11 through a bus or signal line. The timer main body 11 measures time related to an object. The CPU 8 generates information related to time based on an input by the user at the time setting part 2 as will be described later as well as a measurement result from the timer main body 11, and outputs the generated information to the display part 3, light emission part 5 and sound output part 6. Moreover, the CPU 8 controls the light emission part 5 and sound output part 6 based on a light information obtained at the light detection part 4. The storage part 9 is configured by an ROM (Read Only Memory) 19 and an RAM (Random Access Memory) 20, and the CPU 8 performs arithmetic processing based on the program and data stored in the ROM 19 and RAM 20. The CPU 8 records information on the result of the arithmetic processing in the RAM 20.

The timer device 1 may also include a transmission part and a reception part for communication with an external communication apparatus. The timer 1 may also include a date and time measurement part, a frequency divider circuit, an oscillation circuit and the like to display time.

The time setting part 2 includes a time selection part 21 and a time limit setting part 22. When the user presses a button on the time selection part 21, the time unit is switched between day, hour and minute, and the switched time unit is displayed on the display part 3. At the time limit setting part 22, if the time unit corresponds to the unit of days, the display part 3 sequentially shows one day, two days or three days every time the user presses a button in order to input the number of remaining days related to the expiration time limit of a food item. That is, the user sets the unit of days at the time selection part 21 and inputs the number of remaining days related to an expiration time limit of a food item at the time limit setting part 22 based on the set unit of days. The number of days settable at the time limit setting unit 22 may be freely set such as, for example, one to fourteen days. Moreover, though the number of remaining days is automatically counted with the timer main body 11 after the number of remaining days related to the expiration time limit of a food item is input at the time limit setting part 22, the configuration is not limited thereto. For example, the time setting part 2 may also include a time limit measurement part for starting counting of remaining days after the number of remaining days related to the expiration time limit of a food item is input at the time limit setting part 22. Furthermore, counting of the remaining days related to the expiration time limit of a food item may also be started after light detection by the light detection unit 4, which will be described later, is stopped, e.g., after a food item and timer device 1 are stored in a refrigerator.

While the user sets a time unit at the time selection part 21 and inputs the number of remaining days related to an expiration time limit of a food item is input at the time limit setting part 22 based on the set time unit in the present embodiment, the configuration is not limited thereto. For example, it may also be configured that the timer main body 11 automatically counts the number of remaining days only by the user inputting a date corresponding to the expiration time limit of a food item at the time setting part 2. In this case, the input date corresponding to the expiration time limit of the food item is displayed on the display part 3.

The display part 3 is constituted by an LCD (Liquid Crystal Display) and displays information input by the user at the time setting part 2 as described above. Moreover, the display part 3 may also display remaining time related to the expiration time limit of a food item every hour in the case where the number of remaining days related to the expiration time limit of the food item corresponds to one day. For example, if the remaining time related to the expiration time limit of a food item corresponds to twelve hours, the display of “12 h left” is shown on the display part 3. By the display part 3 displaying the remaining time related to the expiration time limit of a food item, the user may be reminded that the expiration time limit of a food item is approaching. The remaining time to be displayed on the display part 3 may be set freely, and the setting may also be executed by the time setting part 2 or a separate setting part. It is also possible to call attention of the user by a text message, not only by the remaining time related to the expiration time limit of a food item, displayed on the display part 3. When the text message is displayed, the content of the message may be changed as the remaining time for the expiration time limit of a food item is reduced.

Though the time setting part 2 and the display part 3 are separately formed in the present embodiment, the configuration is not limited thereto. The time setting part 2 and the display part 3 may integrally be formed using an LCD touch panel or the like. A well-known technique may be applied when an LCD touch panel is formed.

The light detection part 4 may be constituted by a well-known element which detects light. Examples of such element include a photodiode, a photoconductive element and the like. After a food item nipped by the timer device 1 is stored in a refrigerator, when the user opens the refrigerator door and thus the inside of the refrigerator is lightened by the natural light or the illumination light of the refrigerator, the light detection part 4 detects light. The number of the remaining days for the expiration time limit of a food item is counted by the timer main body 11 and the light is detected by the light detection part 4 in the state where the food item nipped by the timer device 1 is stored in the refrigerator, and if the remaining period of the expiration time limit of the food item becomes shorter (if the expiration time limit of the food item is approaching), the light emission part 5 and sound output part 6 operate as will be described later. By the operation of the light emission part 5 and sound output part 6, the user is able to recognize that the remaining period for the expiration time limit of the food item is short.

The light emission part 5 may be constituted by a well-known light emission element, which includes a time limit light emission part 51 and a charge complete light emission part 52. FIG. 1 illustrates three time limit light emission parts 51 that emit green light, yellow light and red light in turn from left in FIG. 1. The color of light emitted by the time limit light emission parts 51 may be changed as the remaining period for the expiration time limit of the food item becomes shorter. That is, the property of light emitted by the time limit light emission part 51 changes in accordance with the time measured. While the time limit light emission part 51 may be constituted by a plurality of display lamps as illustrated in FIG. 1, the configuration is not limited thereto but the number of the time limit light emission parts 51 may be one or more. Though the colors of light emitted by the time limit light emission parts 51 are green, yellow and red in the present embodiment, the configuration is not limited thereto. Another color may be applied to the time limit light emission part 51, or one same color may be applied to a plurality of time limit light emission parts 51. Moreover, instead of emitting light, the time limit light emission part 51 may also flash.

For example, after the user sets the timer device 1 so that the number of remaining days for the expiration time limit of a food item corresponds to a predetermined number of days (e.g., fourteen days) using the time setting part 2 and the food item as well as the timer device 1 are stored in a refrigerator, in the case where the remaining days for the expiration time limit of a food item when the user opens the refrigerator correspond to any one of five to nine days, one to four days or less than one day, the timer device 1 may be so configured that the time limit light emission parts 51 emit lights of green, yellow and red, respectively. That is, the time limit light emission parts 51 may emit light in the order of green, yellow and red as the expiration time limit of a food item approaches, which can remind the user that the expiration time limit of the food item is approaching. It is also possible to display the number of remaining days on the display part 3 described earlier when the time limit light emission part 51 of an arbitrary color emits light. That is, in the case where the number of remaining days for the expiration time limit of a food item when the user opens the refrigerator in the example described above corresponds to four days, the time limit light emission part 51 of yellow emits light while “4 days left” is displayed on the display part 3. By operating both the time limit light emission part 51 and the display part 3, the user may more reliably be reminded that the expiration time limit of a food item is approaching.

The charge complete light emission part 52 is an indication lamp which emits light when electric power is supplied from an external device to a rechargeable battery (not illustrated) embedded in the timer device 1 through a charging unit, which will be described later, and the charging is completed. Furthermore, the charging electrode 7 is an electrode which is to be in contact with the charging unit for supplying electric power from a power source of an external device to the rechargeable battery through the charging unit.

The sound output part 6 outputs buzzer sound or the like when the expiration time limit of a food item approaches to remind the user that the expiration time limit of the food item is approaching. The sound of the buzzer may be changed in stages as the expiration time limit of a food item approaches closer. For example, after the user sets the timer device 1 so that the number of remaining days for the expiration time limit of a food item corresponds to a predetermined number of days (e.g., fourteen days) using the time setting part 2 and the food item as well as the timer device 1 are stored in a refrigerator, in the case where the remaining days for the expiration time limit of a food item when the user opens the refrigerator correspond to any one of five to nine days, one to four days or less than one day, the volume (e.g., small, medium or large) and the sound pitch (e.g., slow, normal or fast) of the buzzer may be changed. That is, the property of the sound output by the sound output part 6 is changed in accordance with the measured time. The sound output part 6 may be so configured that the volume as well as the sound speed of the buzzer may be increased as the number of remaining days for the expiration time limit of a food item is reduced.

Moreover, when the buzzer sound is output in the case where the number of the remaining days for the expiration time limit of a food item is small, it is also possible to emit light of an arbitrary color at the time limit light emission part 51 and to display the number of remaining days on the display part 3, as described earlier. That is, in the example described above, in the case where the number of remaining days for the expiration time limit of a food item when the user opens a refrigerator corresponds to four days, buzzer sound with medium volume and normal pitch is output, and the time limit light emission part 51 emits yellow light while “4 days left” is displayed on the display part 3. By all of the sound output part 6, time limit light emission part 51 and display part 3 being operated, the user may more reliably be reminded that the expiration time limit of a food item is approaching.

Though the sound output part 6 outputs buzzer sound in the present embodiment, it is not limited thereto. The sound output part 6 may also output at least one of sound and voice that can remind the user that the expiration time limit of a food item is approaching. Moreover, all of the sound output part 6, time limit light emission part 51 and display part 3 are not necessarily operated, but any arbitrary one or two of them may be operated.

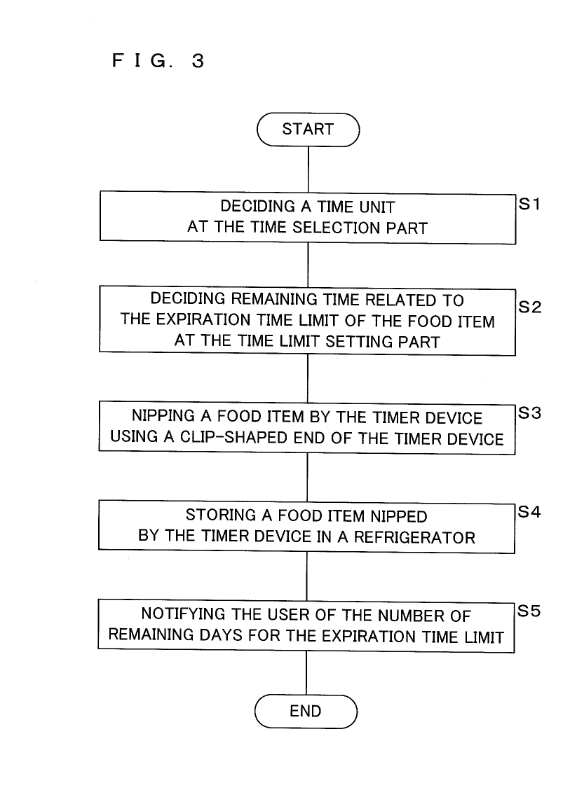

FIG. 3 is a flowchart illustrating a procedure of measuring time related to an object using the timer device according to an embodiment of the present invention. The user decides the time unit at the time selection part 2 based on the expiration time limit of a food item (step S1). The user decides remaining time related to the expiration time limit of the food item at the time limit setting part 22 based on the expiration time limit of a food item (step S2). For example, the user decides the unit of days at the time selection part 21 and decides the number of remaining days related to the expiration time limit of a food item at the time limit setting part 22 based on the decided unit of days.

The user nips the food item with the timer device 1 using a clip-shaped end of the timer device 1 (step S3). Though a food item is nipped by the timer device 1 using the clip-shaped end, the configuration is not limited thereto. As long as the association between the timer device 1 and a food item is clearly identified, the timer device may only be in contact with the food item. The timer device may also be in contact with a bag, container or the like for packaging a food item. Here, the timer device may be formed integrally with a part of the container.

The user stores a food item nipped by the timer device 1 in a refrigerator (step S4). In the case where the remaining time for the expiration time limits of a plurality of food items are measured, steps S1 to S4 are repeated. If the number of remaining days for the expiration time limit of a food item when the user opens the refrigerator corresponds to a predetermined number of days, the timer device 1 notifies the user of the number of remaining days for the expiration time limit using the display part 3, light emission part 5 and sound output part 6 (step S5).

For example, the user sets the timer device 1 such that the number of remaining days for the expiration time limit of a food item corresponds to seven days using the time setting part 2 at steps S1 and S2, and stores the food item nipped by the timer device 1 in the refrigerator at steps S3 and S4. In the case where the number of remaining days for the expiration time limit of a food item when the user opens the refrigerator corresponds to any one of four to six days, two to four days or less than two days, it is so configured that any one of the time limit light emission parts 51 of green, yellow and red appropriately emits light, that the volume (e.g., small, medium or large) and the sound pitch (e.g., slow, normal or fast) of the buzzer output from the sound output part 6 is appropriately changed, and that the number of remaining days is displayed on the display part 3. The operation manners of the time limit light emission part 51, sound output part 6 and display part 3 may be determined in advance, or may be determined based on the set number of remaining days for the expiration time limit. When determined based on the set number of remaining days for the expiration time limit, the operation manners of the time limit light emission part 51, sound output part 6 and display part 3 may be managed in a table. In such a configuration, at step S5, if the number of remaining days for the expiration time limit of a food item when the user opens the refrigerator corresponds to one day, the time limit light emission part 51 emits red light, and the sound output part 6 outputs buzzer sound with a large volume and fast pitch while “1 day left” is displayed on the display part 3.

With the timer device 1 according to the present embodiment, all of the sound output part 6, time limit light emission part 51 and display part 3 are operated so as to reliably remind the user that the expiration time limit of a food item is approaching. Moreover, the user is able to visually and aurally confirm the remaining time for the expiration time limit of each food item stored in a refrigerator at the time point when the user opens a door of the refrigerator, thereby reducing a problem of passing the expiration time limit of a food item. Moreover, since the user is notified of the remaining time for the expiration time limit of a food item both visually and aurally, the user is able to easily search for a food item in the case where the user is visually or aurally impaired, or has difficulty finding a food item in the refrigerator by sound alone.

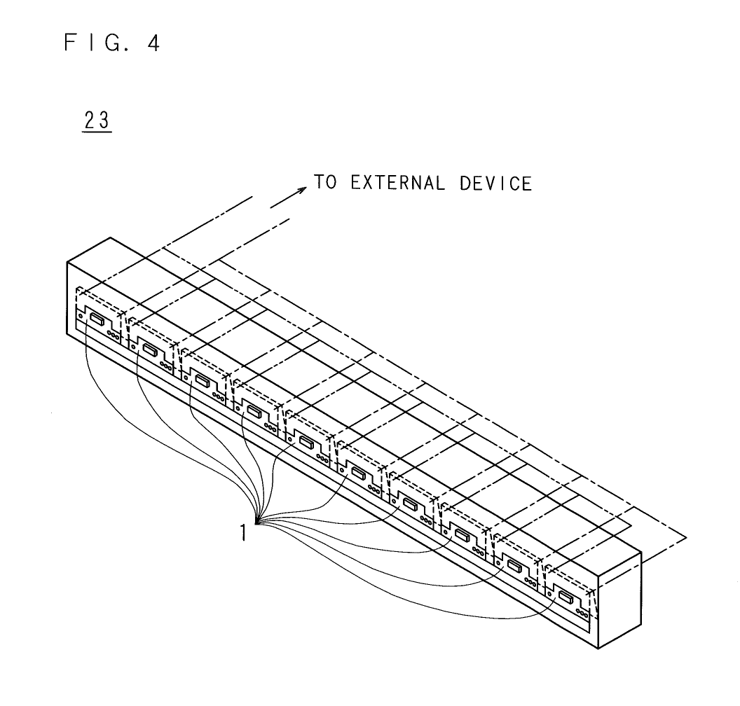

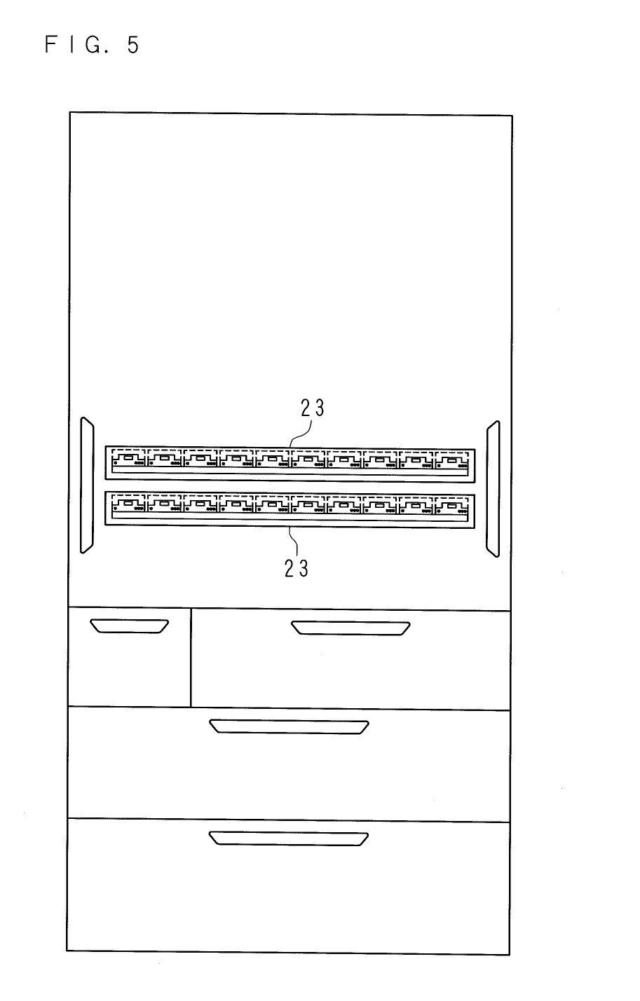

FIG. 4 illustrates a charging unit (power supply device) to/from which a plurality of timer devices 1 according to an embodiment of the present invention are attachable/detachable, and FIG. 5 illustrates a charging unit attached to a door of a refrigerator, according to an embodiment of the present invention. Using a rechargeable battery (not illustrated) included in each timer device 1 and the charging electrode 7, power is supplied from a power source of an external device (e.g., refrigerator) to a plurality of timer devices 1 through the charging unit 23. As illustrated in FIG. 4, approximately ten timer devices 1 arranged in one line may be attached to and detached from the charging unit 23. In the present embodiment, the timer device 1 is inverted so as to have the clip-shaped end thereof is at the top and the timer device 1 is attached to the charging unit 23 while being fitted thereto from the bottom of the charging unit 23, which can avoid accumulation of dust on the charging electrode 7. While the timer device 1 is being set in the charging unit 23, ten timer devices 1 are simultaneously charged in a parallel charging system. When the timer device 1 is set to the charging unit 23, a numeric value set with the time setting part 2 is reset so that the timer device 1 may repeatedly be used. Thereafter, when charging of the timer device 1 is completed, the charge complete light emission part 52 emits light.

A charging device of a well-known parallel charging system may be applied to the charging unit 23. For example, the charging unit 23 may be constituted by a resistor, a comparator, a rectifier, a voltage transformer, a switching element, a controller and the like.

As illustrated in FIG. 5, a plurality of stages of charging units 23 (two stages in FIG. 5) are attached to a door of a refrigerator, so that a plurality of timer devices 1 may be charged at the charging unit 23. Since the charging unit 23 may be attached to the refrigerator door later, the user can decide the number of stages of the charging units 23 to be attached based on the capacity of the refrigerator. Furthermore, such a box-type charging unit 23 may be attached later to other appliances such as a television, not limited to a refrigerator.

With the time measurement system including the plurality of timer devices 1 and charging unit 23 according to the present embodiment, the user can visually and aurally confirm remaining time for an expiration time limit for each food item stored in a refrigerator at the time when the user opens a refrigerator door, thereby reducing a problem of passing the expiration time limit of a food item. Furthermore, the user may repeatedly use the timer device 1 owing to the charging unit 23, and may also decide the number of stages of the charging units 23 to be attached based on the capacity of a refrigerator.

### Embodiment 2

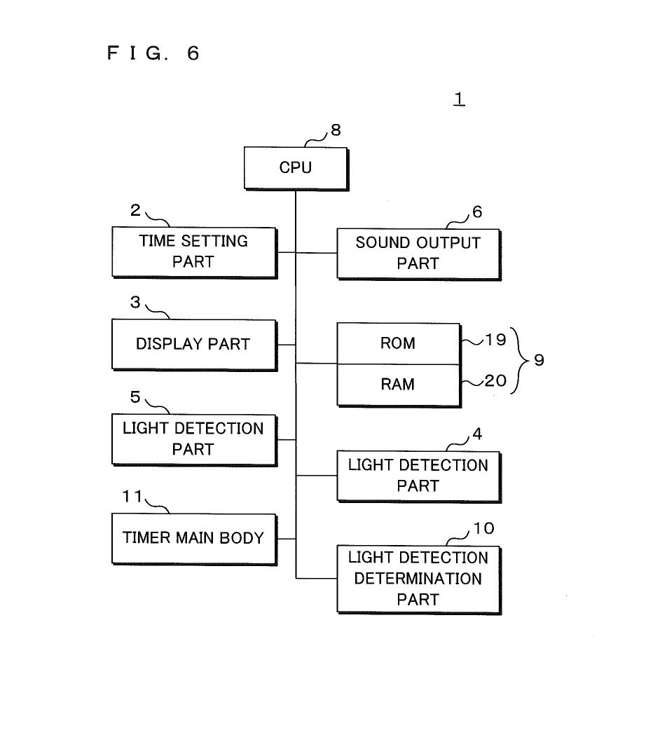

Since the timer device in Embodiment 2 has the same outer appearance as that in Embodiment 1, the description thereof is not repeated here. Differences between the internal structure of the timer device in Embodiment 1 and that in Embodiment 2 will be described below. FIG. 6 illustrates an internal configuration of a timer device according to an embodiment of the present invention. In the present embodiment, a timer device 1 includes a time setting part 2, a display part 3, a light detection part 4, a light emission part 5, a sound output part 6, a CPU 8, a storage part 9, a light detection determination part 10 and a timer main body 11. The CPU 8 is connected to the time setting part 2, display part 3, light detection part 4, light emission part 5, sound output part 6, storage part 9, light detection determination part 10 and timer main body 11 through a bus or signal line. The timer main body 11 measures time related to an object. The CPU 8 generates information related to time based on an input by the user at the time setting part 2 and a measurement result from the timer main body 11, and outputs the generated information to the display part 3, light emission part 5 and sound output part 6. Moreover, the CPU 8 controls the light emission part 5 and sound output part 6 based on the light information obtained at the light detection part 4 and light detection determination part 10. The storage part 9 is constituted by an ROM 19 and RAM 20, and the CPU 8 performs arithmetic processing based on the program and data stored in the ROM 19 and RAM 20. The CPU 8 records the information on the result of the arithmetic processing in the RAM 20.

When the user opens a door of a refrigerator and the inside of the refrigerator is lightened by natural light or illumination light of the refrigerator, the light detection part 4 detects light. When the light detection part 4 detects the light, the light emission part 5 and sound output part 6 operate. Meanwhile, when the light detection part 4 detects light, the light detection determination part 10 starts measuring a predetermined time period based on the light detection information from the light detection part 4. In the case where the light detection part 4 detects light after the predetermined time period has elapsed, i.e., when the inside of the refrigerator is bright, the CPU 8 performs control so that the light emission part 5 and sound output part 6 operate only when the remaining time for the expiration time limit of a food item becomes zero. In Embodiment 1, if the light detection part 4 detects light in the state where the number of remaining days for the expiration time limit of a food item is counted by the timer main body 11 and a food item nipped by the timer device 1 is stored in the refrigerator, in the case where the number of remaining days for the expiration time limit of the food item is small (the expiration time limit of the food item is approaching), the light emission part 5 and sound output part 6 operate. In Embodiment 1, as the light emission part 5 and sound output part 6 keep operating whenever the inside of the refrigerator is bright, sound output by the sound output part 6 may be unpleasant for the user's ear in addition to rapid consumption of a rechargeable battery. In Embodiment 2, on the other hand, in the case where the inside of the refrigerator is bright after a predetermined period of time has elapsed, the light emission part 5 and sound output part 6 do not operate even if the number of remaining days for the expiration time limit of a food item is small, and operate only when the remaining time for the expiration time limit of the food item becomes zero. Therefore, in Embodiment 2, the consumption of a rechargeable battery may be alleviated while sound output by the sound output part 6 may appropriately be limited.

While the light detection determination part 10 starts measuring a predetermined time based on the light detection information from the light detection part 4 in the present embodiment, the configuration is not limited thereto. A measurement part for measuring a predetermined time may be included in the timer device 1 in addition to the light detection determination part 10, and the light detection determination part 10 may determine whether or not the light detection part 4 detects light based on the measurement result of the measurement part. Furthermore, though the CPU 8 performs control such that the light emission part 5 and sound output part 6 operate only when the remaining time for the expiration time limit of a food item becomes zero, it is also possible to define a mode where another device would not operate while the light detection part 4 keeps detecting light and to switch between this mode and a normal operation mode of the timer.

With the timer device 1 according to the present embodiment, the remaining time for the expiration time limit of each food stored in the refrigerator may visually and aurally be confirmed by the user at the time when the user opens a refrigerator door, thereby reducing a problem of passing the expiration time limit of a food item. Moreover, in the case where the inside of the refrigerator is bright after a predetermined time period has elapsed, the light emission part 5 and sound output part 6 operate only when the remaining time for an expiration time limit of a food item is zero, not when the number of remaining days for the expiration time limit of the food item is small, which can suppress the consumption of a rechargeable battery and appropriately limit the sound output by the sound output part 6.

Though the purpose of managing an expiration time limit of a food item stored in a refrigerator has been described in both of Embodiments 1 and 2, the purpose is not limited thereto. The timer device 1 and charging unit 23 may also be applied to various purposes such as setting of cooking time, measurement of preparation time for instant noodle, thawing time for food, time to take in laundry, time to pick up kids at a day-care center, starting time of a TV program, wake-up time and the like.

### Embodiment 3

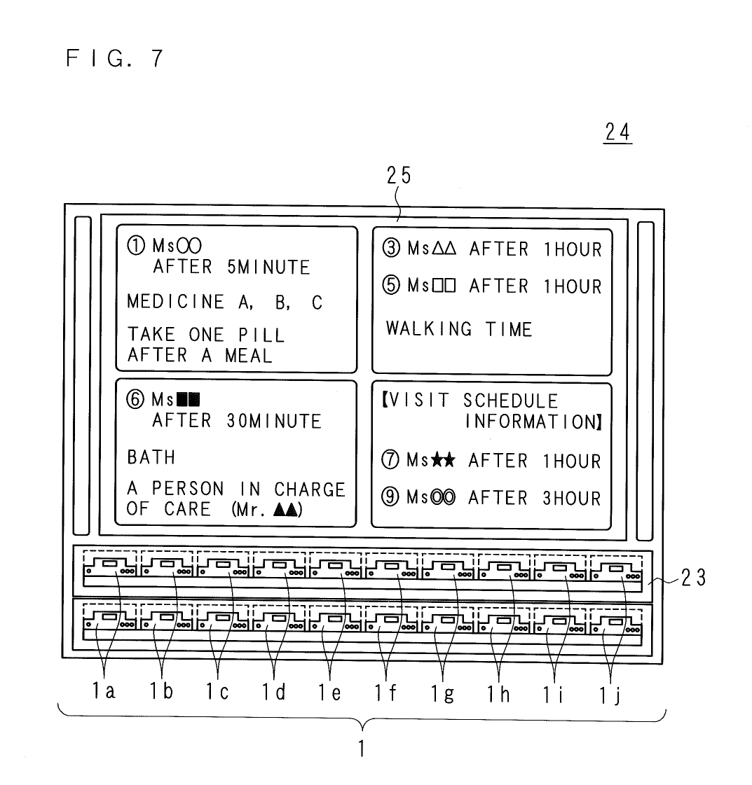

FIG. 7 illustrates a time measurement system including a plurality of timer devices according to the one embodiment of the present invention. A time measurement system 24 according to Embodiment 3 is used to manage, for example, nursing care schedule for ten persons. The time measurement system 24 includes a plurality of timer devices 1, a plurality of charging units 23 and a display device 25. The timer device 1 described in Embodiments 1 and 2 may be partly modified to be applied to the present embodiment as will be described later. The charging unit 23 described earlier may also be applied to the present embodiment. The display device 25 is constituted by a liquid-crystal TV or the like. In the time measurement system 24, the plurality of timer devices 1, the plurality of charging units 23 and display device 25 are connected with one another via wires or without wires.

As illustrated in FIG. 7, ten timer devices 1 are attached to one charging unit 23, and two stages of such charging units 23 are provided in the vertical direction of the drawing. The vertical pairs of timer devices 1 are denoted by numbers 1a to 1j, and each pair is configured to have the same information. In order to prevent the timer device 1 from consuming power and stopping to operate, while one timer device 1 of the pair is being used, the other timer device 1 in the same pair is being supplied with power from a power source of an external device through the charging unit 23.

When connected to the display device 25, the timer device 1 may store a plurality of characters and times, which are input through a touch panel or remote control operation to the screen of the display device 25, in the storage part 9 (RAM 20) of the timer device 1. That is, the same information is to be stored in the storage part 9 of the vertical pair of timer devices 1. For example, on a setting screen of the timer device 1, information related to, for example, a care giver, a care receiver, medicine information (name, number etc. of medicine), time for walk, time for bath and visitor schedule are input. Subsequently, the input information is stored in the storage part 9 of the vertical pair of timer devices 1. Thereafter, either one of the vertical pair of timer devices 1 nipps, for example, clothes of a user, e.g. a care receiver, using a clip-shaped end thereof.

When the time concerning the information input through the display device 25 to the timer device 1 comes, the user is notified of the information through the display part 3, light emission part 5 and sound output part 6 of the timer device 1 nipped clothes or the like. For example, in the case where the information such as “thirty minutes later, person A takes tablet each of medicine B, C and D one by one” is input to the timer device 1 through the display device 25, thirty minutes later, the display part 3 shows that “person A, take one tablet each of medicine B, C and D” while a lamp emits light at the light emission part 5 and a buzzer sound is output at the sound output part 6. These operations by the display part 3, light emission part 5 and sound output part 6 may be set so as to be automatically stopped after a predetermined time period has elapsed, it is also possible that the user him/herself may stop these operations with a stop button added to the timer device 1. Then, when the time concerning the subsequently-input information comes, the timer device 1 notifies the user of the next information through the display part 3, light emission part 5 and sound output part 6. Therefore, the user can infallibly execute the action related to the notified information.

Meanwhile, as illustrated in FIG. 7, when the time related to the information in each timer device 1 approaches, the information stored in each timer device 1 is also displayed in time series on the display device 25. This allows for the management of the schedule of multiple care receivers only by looking at the display device 25, thereby reducing the labor costs. Furthermore, the configuration including the plurality of timer devices 1, plurality of charging units 23 and display device 25 can provide meticulous services for each of the care receivers.

With the time measurement system 24 as in the present embodiment, it is possible for the user to visually and aurally confirm time related to a plurality of objects through a plurality of timer devices, and thus to reduce the problem of passing an expiration time limit concerning each object.

The embodiments disclosed herein are to be construed as illustrative and not restrictive in all aspects. The scope of the invention is defined by the appended claims rather than by the description preceding them, and all changes that fall within metes and bounds of the claims, or equivalence of such metes and bounds thereof are therefore intended to be embraced by the claims.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-8. (canceled)

9. A timer device measuring time related to an object, comprising at least one of:
a light emission part changing a light emission property in accordance with measured time,
a sound output part changing sound output property in accordance with measured time, and
a display part changing a displayed content in accordance with measured time.

10. The timer device according to claim 9, comprising the light emission part, the sound output part and a light detection part, wherein
the light emission part and sound output part are configured to stop operating in a case where the light detection part detects light for a predetermined period.

11. The timer device according to claim 9, further comprising a member for nipping the object.

12. A time measurement system, comprising:
a plurality of timer devices according to claim 9; and
a power supply device simultaneously supplying electric power to the plurality of timer devices.

13. A time measurement system, comprising:
the plurality of timer devices according to claim 11; and
a power supply device simultaneously supplying electric power to the plurality of timer devices,
wherein the member is formed at an end of the timer device, and the member is attached to the power supply device to supply electric power to the timer device.

14. The time measurement system according to claim 12, wherein
each of the plurality of timer devices measures time related to each of a plurality of objects, and
the time measurement system further comprises a display device displaying time obtained by subtracting time measured for each of the plurality of objects from time specified by each of the plurality of objects.

15. The time measurement system according to claim 14, wherein
the plurality of timer devices constitute a pair of timer devices, and
the pair of timer devices measure time related to a same object.

16. The time measurement system according to claim 15, wherein, while one of the pair of timer devices measures time related to the object, the other of the pair of timer devices is supplied with power by the power supply device.
